(19) United States
(12) Patent Application Publication
(10) Pub. No.: US 2022/0092615 A1
(43) Pub. Date: Mar. 24, 2022

(54) METHOD, SYSTEM, AND NON-TRANSITORY COMPUTER READABLE RECORD MEDIUM FOR PROVIDING INFORMATION DATA USING TRANSPORTATION METHOD

(71) Applicant: LINE Corporation, Tokyo (JP)

(72) Inventor: Chien-Wei HU, Tokyo (JP)

(73) Assignee: LINE Corporation, Tokyo (JP)

(21) Appl. No.: 17/481,748

(22) Filed: Sep. 22, 2021

(30) Foreign Application Priority Data
Sep. 24, 2020 (KR) 10-2020-0123647

(51) Int. Cl. G06Q 30/02; G06Q 50/30

(52) U.S. Cl. CPC G06Q 30/0201; G06Q 50/30

(57) ABSTRACT

A method of operating a computer system including at least one processor configured to execute computer-readable instructions included in a memory includes analyzing, by the processor, an interest of a user based on information related to the user; selecting, by the processor, at least one transportation method, from among a first plurality of transportation methods, as an information display method, the selected at last one transportation method being a transportation method that is expected to pass the user, the selecting being based on a location of the user and a location of each transportation method from among the first plurality of transportation methods; and providing information data corresponding to the interest through an external digital display of the selected at least one transportation method.

### CROSS-REFERENCE TO RELATED APPLICATION(S)

This U.S. non-provisional application and claims the benefit of priority under 35 U.S.C. § 365(c) to Korean Patent Application No. 10-2020-0123647, filed Sep. 24, 2020, the entire contents of which are incorporated herein by reference in their entirety.

### BACKGROUND

### 1. Field

One or more example embodiments relate to technology for providing information data.

### 2. Related Art

In many cases, the Internet is used by a user to acquire desired information. Once a query is input, the Internet may simultaneously provide information corresponding to the query and advertising data related thereto, increasing or, alternatively, maximizing the advertising effect.

Due to such advantages, advertising through the Internet is receiving great attention from advertisers as a desirable place to display advertising data.

One example of Internet advertising technology is technology for rolling and displaying a plurality of adverting data on an advertising area of a webpage.

Meanwhile, a bus is a representative public transportation method that operates along a predetermined ground route according to a preset time schedule. Due to characteristics of the bus, the bus is exposed to many passengers and attracts attention as the bus moves.

Various advertising methods using a bus exist, such as installing a billboard on the bus.

However, many advertising methods simply attach and detach an advertising material printed on the paper to the side of a bus and do not increase the advertising effect.

### SUMMARY

At least some example embodiments may provide information data in which a user is interested through an external digital display of a transportation method, such as a bus and a taxi, passing the user based on a location of the user.

At least some example embodiments may provide information data in consideration of area information, season information, and time information through a transportation method passing before boarding of a user that is waiting in a boarding place of the transportation method.

At least some example embodiments may provide information data related to a local facility included in a travel route of a user as information data in which the user is interested through an internal digital display of a transportation method boarded by the user.

According to at least some example embodiments, a method of operating a computer system including at least one processor configured to execute computer-readable instructions included in a memory includes analyzing, by the processor, an interest of a user based on information related to the user; selecting, by the processor, at least one transportation method, from among a first plurality of transportation methods, as an information display method, the selected at last one transportation method being a transportation method that is expected to pass the user, the selecting being based on a location of the user and a location of each transportation method from among the first plurality of transportation methods; and providing information data corresponding to the interest through an external digital display of the selected at least one transportation method.

The analyzing may include collecting the information related to the user through interaction with at least one of an application installed in an electronic device of the user and a service platform used by the user.

The analyzing may include determining a target range by analyzing at least one of a current season, a time zone, a social issue, and profile information including at least one of an age, a gender, an occupation, and an area of the user.

The analyzing may include, when a plurality of users is present in the same place as a target to which the information data is to be provided, collecting information for each user and determining a target range based on statistics or a distribution of the collected information.

The selecting may include selecting, as the information display method, a transportation method of which an estimated time of arrival to the location of the user is less than or equal to an estimated time of arrival of a specific transportation method the user is expected to board.

The selecting may include selecting, as the information display method, a transportation method that is present between the location of the user and a location of a specific transportation method the user is expected to board.

The selecting may include, when a plurality of users is present in the same place as a target to which the information data is to be provided, selecting the information display method by including a transportation method at least partially overlapping between users based on an interest for each user.

The providing may include, when a second plurality of transportation methods, from among the first plurality of transportation methods, is selected as the information display method, providing different information data through an external digital display of each transportation method from among the second plurality of transportation methods.

The providing may include, when a second plurality of transportation methods, from among the first plurality of transportation methods, is selected as the information display method, applying time information according to a remaining distance or an estimated time of arrival to the location of the user for each transportation method from among the second plurality of transportation methods and providing the information data through an external digital display of a corresponding transportation method.

The providing may include providing the information data by jointly using at least one of a digital display installed in a boarding place of the transportation method and a digital display installed in an outdoor facility around the boarding place.

The providing may include providing information data related to at least one of a local facility included in a route of a specific transportation method boarded by the user and a destination of the user through an internal digital display of the specific transportation method.

The providing may include providing at least a portion of the information data through an application installed in an electronic device of the user after the user boards a specific transportation method.

According to at least some example embodiments, a non-transitory computer-readable record medium stores instructions that, when executed by a processor, cause the processor to perform the method of operating a computer system.

According to at least some example embodiments, a computer system includes memory storing computer-readable instructions; and at least one processor configured to execute the computer-readable instructions such that the processor is configured to analyze an interest of a user based on information related to the user, select at least one transportation method, from among a first plurality of transportation methods, as an information display method, the selected at last one transportation method being a transportation method that is expected to pass the user, the selecting being based on a location of the user and a location of each transportation method from among the first plurality of transportation methods, and provide information data corresponding to the interest through an external digital display of a transportation method selected as the information display method.

The at least one processor may be further configured to collect the information related to the user through interaction with at least one of an application installed in an electronic device of the user and a service platform used by the user and to analyze the interest.

The at least one processor may be further configured to, when a plurality of users is present in the same place as a target to which the information data is to be provided, collect information for each user and determine a target range based on statistics or a distribution of the collected information.

The at least one processor may be further configured to select, as the information display method, a transportation method of which an estimated time of arrival to the location of the user is less than or equal to an estimated time of arrival of a specific transportation method the user desires to board, or a transportation method that is present between the location of the user and a location of the specific transportation method the user is expected to board.

The at least one processor may be further configured to, when a second plurality of transportation methods, from among the first plurality of transportation methods, is selected as the information display method, provide different information data through an external digital display of each transportation method from among the second plurality of transportation methods.

The at least one processor may further configured to provide the information data by jointly using at least one of a digital display installed in a boarding place of the transportation method and a digital display installed in an outdoor facility around the boarding place.

The at least one processor may be further configured to provide information data related to at least one of a local facility included in a route of a specific transportation method boarded by the user and a destination of the user through an internal digital display of the specific transportation method.

Further areas of applicability will become apparent from the description provided herein. The description and specific examples in this summary are intended for purposes of illustration only and are not intended to limit the scope of the present disclosure.

### BRIEF DESCRIPTION OF DRAWINGS

The above and other features and advantages of example embodiments of the inventive concepts will become more apparent by describing in detail example embodiments with reference to the attached drawings. The accompanying drawings are intended to depict example embodiments and should not be interpreted to limit the intended scope of the claims. The accompanying drawings are not to be considered as drawn to scale unless explicitly noted.

FIG. 1 illustrates an example of a content providing environment according to at least one example embodiment;

FIG. 2 illustrates an example of an internal configuration of a computer system according to at least one example embodiment;

FIG. 3 illustrates an example of an information data providing environment using a transportation method according to at least one example embodiment;

FIG. 4 illustrates an example of a component includable in a processor of a computer system according to at least one example embodiment;

FIG. 5 is a flowchart illustrating an example of a method performed by a computer system according to at least one example embodiment; and

FIGS. 6 to 10 illustrate examples of displaying information data according to at least one example embodiment.

### DETAILED DESCRIPTION

One or more example embodiments will be described in detail with reference to the accompanying drawings. Example embodiments, however, may be embodied in various different forms, and should not be construed as being limited to only the illustrated embodiments. Rather, the illustrated embodiments are provided as examples so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated.

As used herein, the singular forms “a,” “an,” and “the,” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups, thereof. As used herein, the term “and/or” includes any and all combinations of one or more of the associated listed products. Expressions such as “at least one of,” when preceding a list of elements, modify the entire list of elements and do not modify the individual elements of the list. Also, the term “exemplary” is intended to refer to an example or illustration.

Unless otherwise defined, all terms (including technical and scientific terms) used herein have the same meaning as commonly understood by one of ordinary skill in the art to which example embodiments belong. Terms, such as those defined in commonly used dictionaries, should be interpreted as having a meaning that is consistent with their meaning in the context of the relevant art and/or this disclosure, and should not be interpreted in an idealized or overly formal sense unless expressly so defined herein.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as one computer processing device; however, one skilled in the art will appreciate that a hardware device may include multiple processing elements and multiple types of processing elements. For example, a hardware device may include multiple processors or a processor and a controller. In addition, other processing configurations are possible, such as parallel processors.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

Hereinafter, at least some example embodiments will be described with reference to the accompanying drawings.

At least some example embodiments relate to technology for providing information data using a transportation method, such as, for example, a bus and a taxi.

At least some example embodiments including disclosures herein may provide information data corresponding to an interest of a user through an external digital display of a transportation method that passes the user.

The term “information data” used herein may refer to any types of contents providable through the Internet or computer communication, such as, for example, movie information, news, a video, an image, and a community post as well as advertising content.

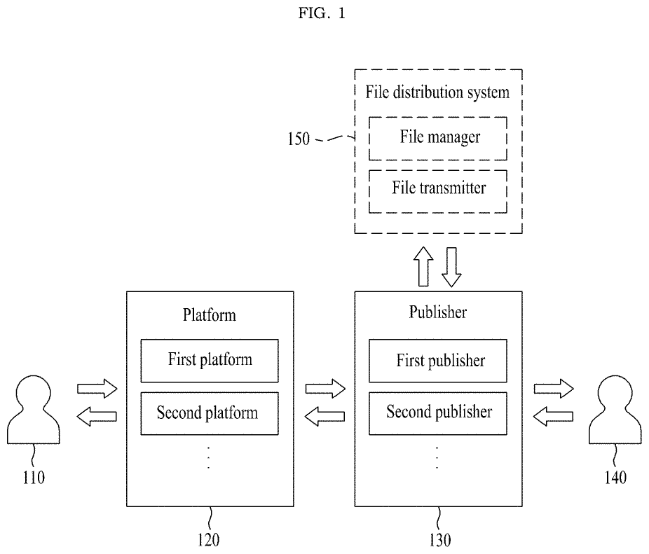

FIG. 1 illustrates an example of a content providing environment according to at least one example embodiment. Here, FIG. 1 illustrates a content provider 110, a platform 120, a publisher 130, and a user 140. Here, the content provider 110 and the user 140 may substantially refer to an electronic device, such as, for example, a personal computer (PC) and a smartphone used by the content provider 110 or the user 140. That is, in FIG. 1, indicators each with an arrowhead among the content provider 110, the platform 120, the publisher 130, and the user 140 may represent that data may be transmitted and received over a wired/wireless network among an electronic device used by the content provider 110, the platform 120, the publisher 130, and an electronic device used by the user 140.

The platform 120 may refer to a system that performs bidding for content provided as information data of the content provider 110, matching between targeting elements for a user to which content is to be provided, content arrangement, and billing to the content provider 110 according to providing and displaying content to the publisher 130.

The term “publisher” used herein may be interchangeably used with the term “site.” Here, description using the term “site” does not exclude a possibility of implementing at least some example embodiments in an environment other than a general PC website connection, such as an application screen executed on an electronic device. Conversely, the term “site” may be interchangeably used with the term “publishing site” or “publisher.” That is, the respective sites may correspond to individual publishers, for example, a first publisher, a second publisher, etc., included in the publisher 130, respectively. Here, each of the individual publishers may be implemented as one or more publisher servers. The term “site” may include any types of websites capable of displaying content and providing the content to the user 140 over a wired network or a wireless network, and may refer to a single webpage that constitutes a website.

Also, the expression “exposing/displaying” of content used herein may be interpreted to include providing promotional content associated with the content provider 110, that is, information data to a visitor of a corresponding website through the publisher 130.

The publisher 130 may receive contents to be provided through a site of the publisher 130 from the platform 120 and may provide the received contents to the user 140. For example, the publisher 130 may receive information data from the platform 120 and may provide the information data to the user 140 as additional content corresponding to an item purchased by the user 140, content consumed by the user 140, a keyword included in a search query input from the user 140 or conversation data of a messenger, or other behavioral analysis results.

As described above, the publisher 130 may provide a path through which the user 140 directly receives content. In a general online environment, contents may be provided through a website/mobile site. Here, each of a plurality of individual platforms, for example, a first platform, a second platform, etc., included in the platform 120 may display content through at least one individual publisher among the plurality of individual publishers, for example, the first publisher, the second publisher, etc., included in the publisher 130. Here, each of the individual platforms may be implemented as one or more platform servers.

According to at least some example embodiments, a display device installed inside/outside a transportation method, a display device installed in a boarding place (e.g., a stop) of the transportation method, and a display device installed in an outdoor facility around a road through which the transportation method passes may serve as a publisher that receives contents from the platform 120 and provides the contents to the user 140.

Referring to FIG. 1, a file distribution system 150 may be selectively used depending on necessity. For example, when the user 140 uses an electronic device, the file distribution system 150 may provide the user 140 with a file for installing an application associated with the publisher 130 on the electronic device. To this end, the file distribution system 150 may include a file manager configured to store and manage the file and a file transmitter configured to transmit the file to the electronic device of the user 140 in response to a request from the electronic device of the user 140. The application may be installed in the electronic device using the transmitted file and the application may control the electronic device to perform operations for providing content according to at least some example embodiments.

At least some example embodiments may apply the content providing environment of FIG. 1. Here, an operator of the platform 120 may design the platform 120 such that the content provider 110 may select or input information data that is content of the content provider 110, a keyword or a category for each piece of content, and targeting information (e.g., an age, a gender, a field of interest, an area, a season, a time zone, etc.). The content provider 110 may upload the content to the platform 120 and may register the content of the content provider 110 to the platform 120 through bidding.

A program associated with the publisher 130 may be installed in the electronic device used by the user 140. For example, the program may be installed in the electronic device of the user 140 in an application form or a plug-in form and may control the electronic device of the user 140 or a web browser installed in the electronic device of the user 140 to output information provided from the publisher 130.

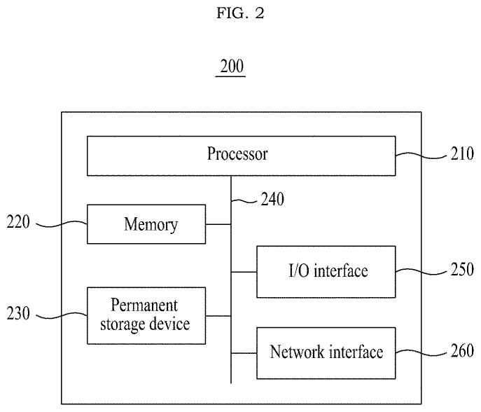

FIG. 2 is a diagram illustrating an example of an internal configuration of a computer system according to at least one example embodiment. For example, an information data providing system according to at least one example embodiment may be implemented through a computer system 200 of FIG. 2. The information data providing system described herein may be a computer system that constitutes a single platform among the plurality of individual platforms of FIG. 1.

Referring to FIG. 2, the computer system 200 may include a processor 210, a memory 220, a permanent storage device 230, a bus 240, an input/output (I/O) interface 250, and a network interface 260 as components to perform an information data providing method according to at least one example embodiment.

The processor 210 may include any device capable of processing a sequence of instructions or a portion thereof. The processor 210 may include, for example, a computer processor, a processor in a mobile device or another electronic device, and/or a digital processor. The processor 210 may be included in, for example, a server computing device, a server computer, a series of server computers, a server farm, a cloud computer, a content platform, a mobile computing device, a smartphone, a tablet, and a set-top box. The processor 210 may connect to the memory 220 through the bus 240.

The memory 220 may include a volatile memory, a permanent memory, a virtual memory, or other memories configured to store information used by the computer system 200 or output from the computer system 200. The memory 220 may include, for example, random access memory (RAM) and/or dynamic RAM (DRAM). The memory 220 may be used to store any information, for example, state information of the computer system 200. The memory 220 may be used to store instructions of the computer system 200 that include, for example, instructions for providing content. If necessary or in an appropriate case, the computer system 200 may include at least one processor 210.

The bus 240 may include a communication-based structure that enables interaction between various components of the computer system 200. The bus 240 may transport data between the components of the computer system 200, for example, between the processor 210 and the memory 220. The bus 240 may include wireless and/or wired communication media between the components of the computer system 200 and may include parallel, serial, or other topology arrangements.

The permanent storage device 230 may include components, such as a memory or another permanent storage device used by the computer system 200, to store data during a predetermined extended period of time compared to, for example, the memory 220. The permanent storage device 230 may include a non-volatile main memory used by the processor 210 in the computer system 200. The permanent storage device 230 may include, for example, a flash memory, a hard disk, an optical disc, and other computer-readable record media.

The I/O interface 250 may include interfaces for a keyboard, a mouse, a voice instruction input, a display, and other input or output devices. Configuration instructions and/or input related to content providing may be received through the I/O interface 250.

The network interface 260 may include at least one interface for networks, such as, for example, a local area network and the Internet. The network interface 260 may include interfaces for wired or wireless connections. The configuration instructions and/or information related to content providing may be received or transmitted through the network interface 260.

Also, according to at least one other example embodiment, the computer system 200 may include a number of components greater than or less than the number of components of FIG. 2. However, there is no need to clearly illustrate many components according to the related art. For example, the computer system 200 may be implemented to include at least a portion of I/O devices connected to the I/O interface 250 or may further include other components, such as, for example, a transceiver, a global positioning system (GPS) module, a camera, various types of sensors, and a database.

Hereinafter, at least some example embodiments of a method and system for providing information data using a transportation method are described.

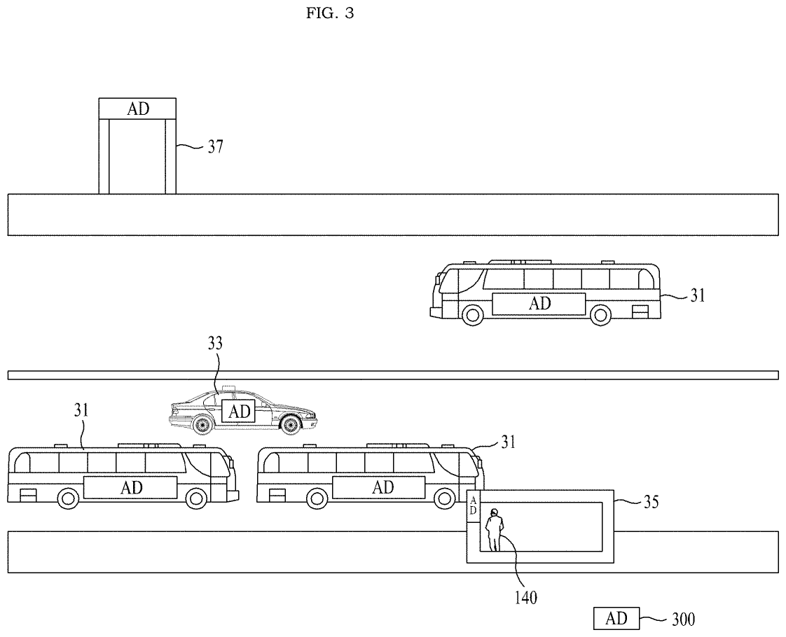

FIG. 3 illustrates an example of an information data providing environment using a transportation method according to at least one example embodiment.

Referring to FIG. 3, the computer system 200 may provide information data corresponding to an interest of the user 140 using a transportation method that passes the user 140, based on a location of the user 140.

The transportation method may encompass various types of transportation methods such as a bus 31 and a taxi 33. The computer system 200 may display information data through an external digital display 300 of the bus 31 or the taxi 33.

The external digital display 300 may be installed in at least one side of a body of the transportation method, for example, the bus 31 and the taxi 33, and the computer system 200 may display information data in which the user 140 is interest through the external digital display 300 installed at a location that faces the user 140 among the external digital displays 300 of the transportation methods.

Also, to provide information data to the user 140, the computer system 200 may additionally use the external digital display 300 installed in at least one of a boarding place (e.g., a stop) 35 of the transportation method and an outdoor facility 37 around a road in addition to the external digital display 300 of the transportation method, for example, the bus 31 and the taxi 33.

The computer system 200 may display the same information data or may display different information data linked in a form of a story through at least two external digital displays 300.

In the case of providing information data using at least two external digital displays 300, the computer system 200 may collectively display the information data at the same point in time or may individually display the information data by applying a time difference according to a distance from the user 140.

The external digital display 300 installed in, for example, the transportation method such as the bus 31 or the taxi 33, the boarding place 35, and the outdoor facility 37, may be implemented as a computer apparatus capable of directly communicating with the computer system 200 to display the information data provided from the computer system 200. According to at least some example embodiments, the external digital display 300 may be implemented as an output device that displays information data provided from the computer system 200, through a separate computing device (e.g., a mobile computing device, a smartphone, a tablet, a set-top box, etc.) that is capable of interacting with the computer system 200.

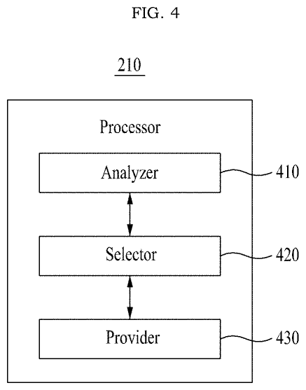

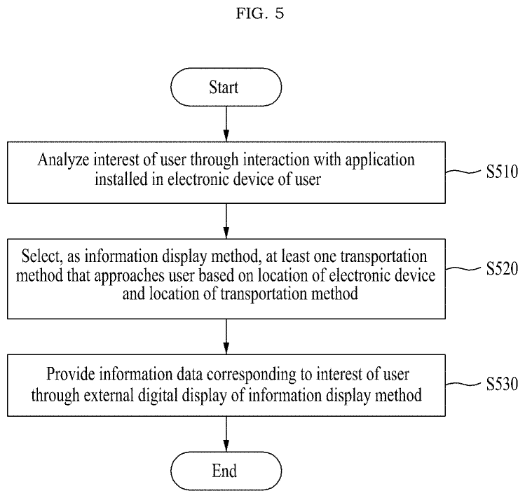

FIG. 4 illustrates an example of a component includable in a processor of a computer system according to at least one example embodiment, and FIG. 5 is a flowchart illustrating an example of a method performed by a computer system according to at least one example embodiment.

Referring to FIG. 4, the processor 210 of the computer system 200 may include an analyzer 410, a selector 420, and a provider 430 to perform an information data providing method of FIG. 5.

According to at least some example embodiments, the components of the processor 210 may be selectively included in or excluded from the processor 210. Also, according to at least some example embodiments, the components of the processor 210 may be separated or merged for functional representations of the processor 210.

The processor 210 and the components of the processor 210 may control the computer system 200 to perform operations S510 to S530 included in the information data providing method of FIG. 5. For example, the processor 210 and the components of the processor 210 may be configured to execute an instruction according to a code of at least one program and a code of an OS included in the memory 220.

Here, the components of the processor 210 may be representations of different functions performed by the processor 210 in response to an instruction provided from a program code stored in the computer system 200. For example, the analyzer 410 may be used as a functional representation of the processor 210 that controls the computer system 200 to analyzer an interest of the user according to the instruction.

The processor 210 may read a necessary instruction from the memory 221 to which instructions associated with control of the computer system 200 are loaded. In this case, the read instruction may include an instruction for controlling the processor 210 to perform the following information data providing method.

The following information data providing method may be performed in order different from the illustrated order. A portion of operations S510 to S530 included in the information data providing method may be omitted. Alternatively, an additional process may be further included.

Referring to FIG. 5, in operation S510, the analyzer 410 may analyze an interest of a user through interaction with an application installed in an electronic device of the user.

The computer system 200 may refer to a computer system that is included in a social platform configured to provide a social service such as a messenger or constitutes a platform that is capable of interacting with the social platform. Also, the computer system 200 may be a computer system that is included in a portable platform configured to provide a portable service such as a search, a shopping, and a game, or constitutes a platform that is capable of interacting with the portable platform.

Also, the computer system 200 may refer to a computer system that is included in a transportation method platform configured to provide a location and an estimated time of arrival of a transportation method or to provide a call service for the transportation method, or constitutes a platform that is capable of interacting with the transportation method platform.

The analyzer 410 may collect information related to the corresponding user based on identification information (e.g., an ID) of the user through interaction with the application installed in the electronic device of the user or another platform and may analyze the interest of the user as an example of a target range. For example, the analyzer 410 may analyze the interest of the user based on a behavioral analysis result of the user, such as a keyword included in a search query input from the user or conversation data of a messenger, a product frequently or currently purchased by the user, and a frequently visited place.

The analyzer 410 may determine the target range through the overall profiling using user profile information such as an age, a gender, an occupation, and an area (e.g., a residential area and a current location) of the user, a current season, a time zone, and a social issue in addition to the interest of the user.

When a plurality of users is present in the same place as a target to which information data is to be provided, the analyzer 410 may collect information for each user and may determine the target range based on statistics or distribution of the collected information. For example, the analyzer 410 may determine an average age group of users or an age group with a highest user distribution as a target range. As another example, the analyzer 410 may determine the target range that is statistically expected to have a highest interest based on a common interest determined for the plurality of users or profiles of the plurality of users.

Therefore, the analyzer 410 may determine the target range by collecting and analyzing information related to the user through various routes, for example, an app or a service used by the user that is capable of interacting with the computer system 200.

In operation S520, the selector 420 may select at least one transportation method that approaches the user based on a location of the electronic device of the user and a location of the transportation method.

A global positioning system (GPS) is embedded in all the transportation methods and the computer system 200 may receive and use location information that is directly provided from each transportation method, or may use location information of each transportation method provided from an application installed in the electronic device of the user.

When the user is present within a predetermined (or, alternatively, desired) radius based on a location that is determined as a boarding place of the transportation method, the selector 420 may select a transportation method (hereinafter, referred to as an information display method) that passes the user (or the boarding place of the transportation method) as the transportation method for displaying information data.

For example, the selector 420 may select, as the information display method, a transportation method that is expected to pass the user for an estimated period of time until a transportation method specified by the user (e.g., a transportation method the user desires to, or is expected to, board) (hereinafter, referred to as a boarding target method) arrives at the boarding place. The selector 420 may verify an estimated time of arrival for each transportation method with respect to the boarding place in which the user is present and may select, as the information display method, a transportation method of which an estimated time of arrival is less than or equal to an estimated time of arrival of the boarding target method. The boarding target method may also be included in the information display method. For example, with the assumption that the boarding target method is scheduled to arrive in 5 minutes, the selector 420 may verify a transportation method with an estimated time of arrival of 5 minutes or less as a transportation method that is expected to pass in front of the user and may determine the corresponding transportation method as the information display method.

As another example, the selector 420 may select, as the information display method, a transportation method present between a location of the boarding target method and a location of the user based on the location of the boarding target method and the location of the user.

When a plurality of users with different boarding target methods is present in the same boarding place, the selector 420 may select the information display method based on a boarding target method that is scheduled to arrive last or a boarding target method of which an estimated time of arrival or a location is an intermediate value.

As another example, the selector 420 may dividedly select an information display method for each user. The selector 420 may select at least one transportation method as the information display method based on a location of each user to prevent the information display method from overlapping between users, and may also select the information display method by including a partially overlapping transportation method based on a target range analyzed for each user. For example, the same transportation method may be selected as the information display method for users having the same interest.

In operation S530, the provider 430 may provide content in which the user is interested by displaying information data corresponding to the interest of the user on an external digital display of the transportation method selected as the information display method. The provider 430 may provide information data corresponding to the target range that is determined based on not only the interest of the user but also the analysis result in operation S510 through a digital display of the information display method.

When at least two transportation methods are selected as the information display method for the user, the provider 430 may display the same information data or may display different information data linked in a form of a story on an external digital display of each transportation method.

When at least two transportation methods are selected as the information display method for the user, the provider 430 may collectively display the information data at the same point in time or may individually display the information data by applying a time difference according to a distance from the user, on an external digital display of each transportation method. For example, the provider 430 may display information data on an external digital display of a corresponding information display method from a point in time at which an estimated time of arrival of the information display method to a location (e.g., boarding place) of the user is 1 minute remaining.

A period of time for maintaining displaying of the information data may be predetermined. According to at least some example embodiments, displaying of the information data may be maintained until a location of the information display method reaches the location of the user or until the location of the information display method is away from the user by a predetermined (or, alternatively, desired) distance or more.

The provider 430 may provide information data corresponding to the target range by jointly using digital displays installed in a boarding place and an outdoor facility around the boarding place in addition to an external digital display of the transportation method selected as the information display method.

A target range determined through pre-analysis for each boarding place of the transportation method may be accumulated. Here, the provider 430 may provide information data corresponding to a target range accumulated for a specific boarding place to a user that is waiting in the specific boarding place through a digital display of an information display method. For example, in the case of a stop near a school, the provider 430 may display information data targeted for students through an external digital display of a transportation method that passes through the stop in a time zone in which the students leave the school.

Therefore, the provider 430 may provide different information data according to an interest of a corresponding user, an age, a gender, and an occupation of the user, an area, a current season, a time zone, and a social issue using an external digital display of a corresponding transportation method.

The provider 430 may verify a transportation method boarded by the user and may display information data through an internal digital display of the corresponding transportation method. For example, the provider 430 may provide information data related to a local facility (point of interest (POI)) included in a route through which the user moves while boarding the corresponding transportation method or a fixed route of the transportation method as information data in which the user is interested, through the internal digital display of the transportation method boarded by the user. When a destination using a transportation method is set through an application (e.g., a bus location finding app) installed in the electronic device of the user, the provider 430 may acquire the destination and may provide information data related to the destination.

As another example, after the user boards a transportation method, the provider 430 may provide the user with at least a portion of information data that is displayed on an external digital display of the transportation method selected as an information display method for the user through an application (e.g., a messenger app and a bus location finding app) installed in the electronic device of the user. The provider 430 may transfer all the provided information data to the user while the user is waiting in a boarding place or may transfer information data displayed through the transportation method boarded by the user.

The processor 210 may accurately verify visibility of information data since it is possible to know display time information of information data, location information of the transportation method, a location of the user, and time information for each location. For example, the processor 210 may measure a number of times information data is actually displayed by comparing display time information of the information data and location information of the transportation method to information collected for the user, for example, the location of the user and time information for each location. Also, the processor 210 may measure a ratio (e.g., a conversation rate) of actual conversations to a number of times the information data is displayed. The processor 210 may perform billing based on the number of times the information data using the transportation method is displayed or the conversation rate.

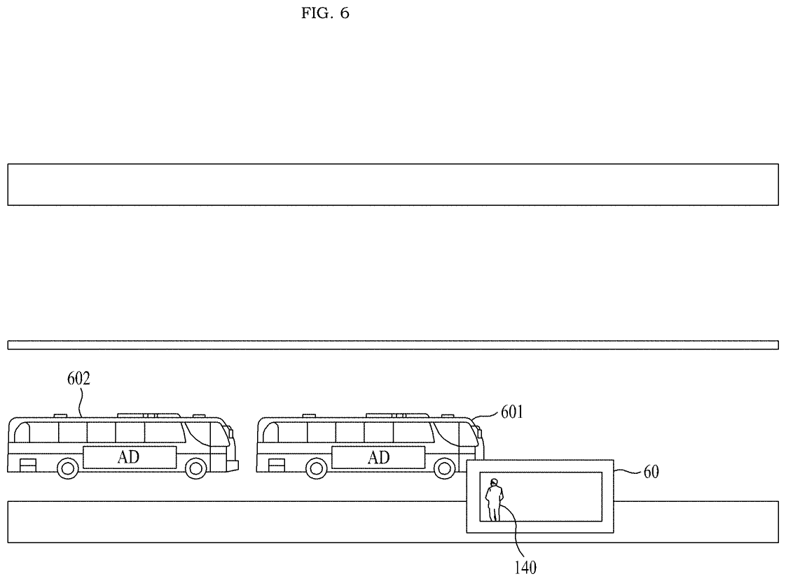

FIGS. 6 to 10 illustrate examples of exposing information data according to at least one example embodiment.

Referring to FIG. 6, when the user 140 is waiting in a stop 60 to board a bus, the processor 210 may display an advertisement (AD) corresponding to an interest of the user 140 on an external digital display of a bus 601, 602 that passes the user 140. When a plurality of users is present in the stop 60, the processor 210 may collect information for each user and may display an AD that is determined based on statistics or distribution of the collected information.

The processor 210 may display the AD on the external digital display of the bus 601, 602 that passes in front of the user 140 among buses moving in a direction corresponding to a location of the user 140.

As another example, to provide information data in a situation in which transportation methods travel in both directions based on a location of the user 140, the processor 210 may use a transportation method that moves in a direction corresponding to the location of the user 140 and may also use a transportation method that moves in an opposite direction.

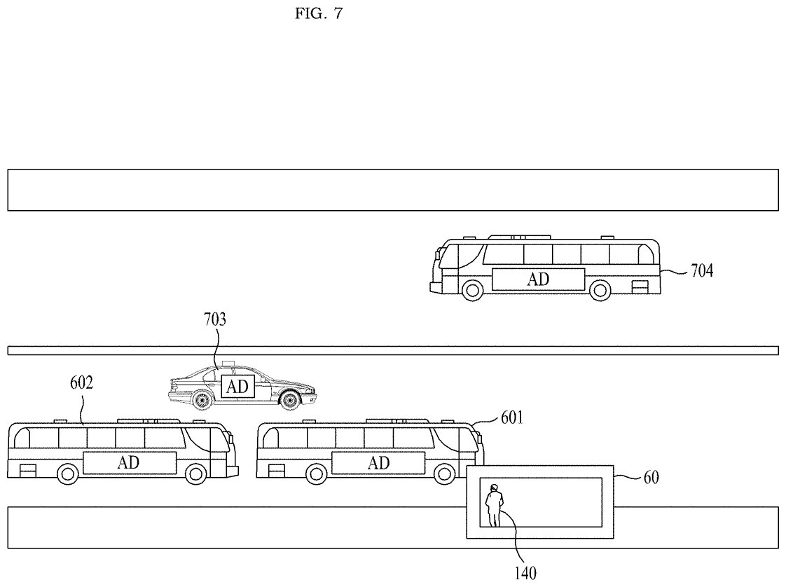

Referring to FIG. 7, the processor 210 may display an AD corresponding to an interest of the user 140 through an external digital display of a bus 704 that passes in front of the user 140 in a direction opposite to a location of the user 140. Also, the processor 210 may display an AD corresponding to the interest of the user 140 through an external digital display of a transportation method different from a transportation method the user 140 desires to board, for example, a taxi 703.

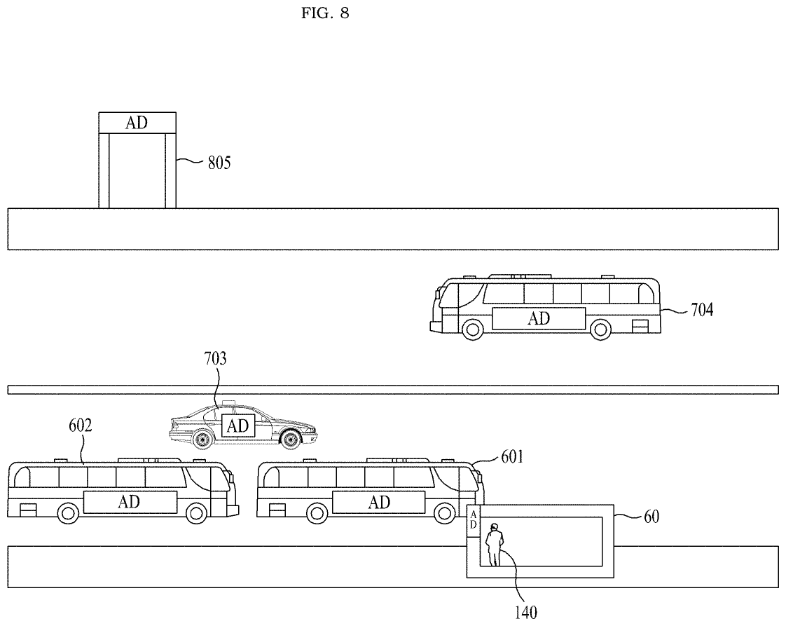

As another example, referring to FIG. 8, the processor 210 may also display an AD corresponding to an interest of the user 140 using a digital display installed in the stop 60 or a digital display installed in an outdoor facility 805 around the stop 60 in addition to the bus 601, 602, 704, or the taxi 703 that passes in front of the user 140.

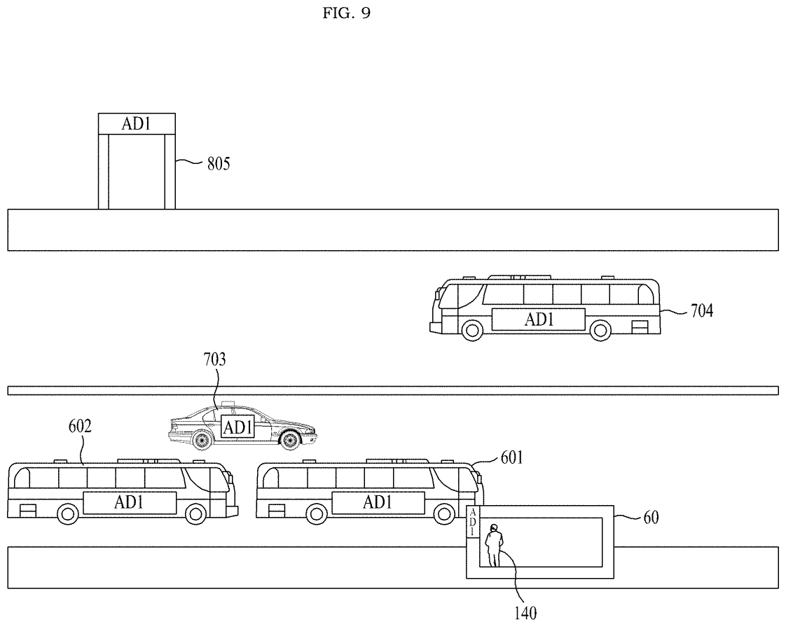

Referring to FIG. 9, the processor 210 may display a single identical advertisement “AD1” as an AD corresponding to an interest of the user 140 through at least two digital displays, for example, digital displays of the buses 601, 602, and 704, and the taxi 703 passing in front of the user 140, the stop 60, and the outdoor facility 805.

According to at least some example embodiments, the processor 210 may divide the advertisement “AD1” and may dividedly display the advertisement “AD1” on the digital displays of the buses 601, 602, and 704, and the taxi 703 passing in front of the user 140, the stop 60, and the outdoor facility 805. For example, when the advertisement “AD1” includes a character string “abcdefghijkl,” the processor 210 may display a character string “ab” on the digital display of bus 601, a character string “cd” on the digital display of the bus 602, a character string “ef” on the digital display of the taxi 703, a character string “gh” on the digital display of the bus 704, a character string “ij” on the digital display of the stop 60, and a character string “kl” on the digital display of the outdoor facility 805. The processor 210 may also divide and thereby display a playback section or an image area of an advertisement such as a video or an image.

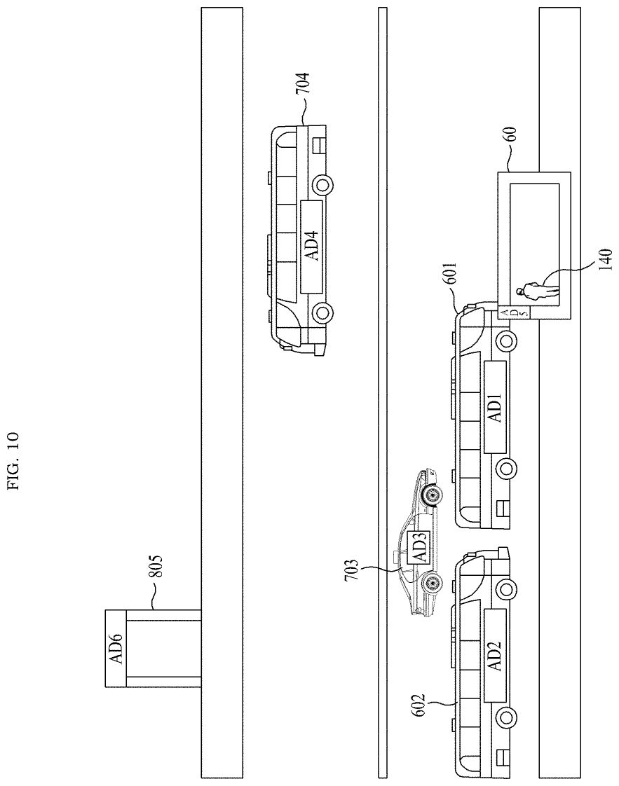

As another example, the processor 210 may display different advertisements as an AD corresponding to an interest of the user 140 through at least two digital displays. For example, referring to FIG. 10, the processor 210 may display an advertisement “AD1” on the bus 601 passing in front of the user 140, an advertisement “AD2” on the digital display of the bus 602, an advertisement “AD3” on the digital display of the taxi 703, an advertisement “AD4” on the digital display of the bus 704 opposite to a location of the user 140, an advertisement “AD5” on the digital display of the stop 60, and an advertisement “AD6” on the digital display of the outdoor facility 805.

In the case of displaying an advertisement using a plurality of transportation methods, the processor 210 may start collectively displaying the advertisement through an external digital display of each transportation method at the same point in time based on a point in time at which a corresponding transportation method is selected as an information display method regardless of a distance from the user 140 and may terminate displaying of the advertisement upon arrival at a location of the user 140.

Alternatively, in the case of displaying an advertisement using a plurality of transportation methods, the processor 210 may display the advertisement according to a remaining distance or an estimated time of arrival to a location of the user 140 for each transportation method. For example, for each transportation method, the processor 210 may start individually displaying an advertisement on an external digital display of a corresponding transportation method from a point in time at which a remaining distance to the location of the user 140 reaches a predetermined (or, alternatively, desired) distance (e.g., 500 meters) or a point in time at which an estimated time of arrival to the location of the user 140 is 1 minute remaining and may terminate displaying of the advertisement when the corresponding transportation reaches the location of the user 140.

Additionally, the processor 210 may transmit corresponding advertisement-related information to the electronic device of the user 140 such that at least a portion of an advertisement displayed on an external digital display of each transportation method in association with the user 140 may be consecutively displayed for the user 140 after the user 140 boards the corresponding transportation method.

The processor 210 may display an advertisement in a mutually linked configuration using a plurality of transportation methods. For example, with the assumption that four buses are passing in front of the user 140, the processor 210 may display an image or a video of a product in which the user 140 is interested on three buses that pass first and may display site information about a site at which the user 140 may purchase the corresponding product on the bus that passes last.

According to at least some example embodiments, it is possible to determine a target range by collecting and analyzing information related to a user through various routes such as an app and a service used by the user and to provide information data corresponding to the target range through an external digital display of a transportation method, such as a bus and a taxi, that passes the user based on a location of the user.

The apparatuses described above (e.g., the platform 120, the publisher 130, the file distribution system 150, the computer system 200, etc.) may be implemented using hardware components, software components, and/or a combination thereof. For example, one or more of the elements disclosed above may include or be implemented in one or more processing circuitries such as hardware including logic circuits; a hardware/software combination such as a processor executing software; or a combination thereof. For example, the processing circuitries more specifically may include, but are not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), or any other device capable of responding to and executing instructions in a defined manner. An example of the processing circuitries may include a processing device that runs an operating system (OS) and one or more software applications that run on the OS. The processing device also may access, store, manipulate, process, and create data in response to execution of the software. For simplicity, the description of a processing device is used as singular; however, one skilled in the art will be appreciated that a processing device may include multiple processing elements and/or multiple types of processing elements. For example, a processing device may include multiple processors or a processor and a controller. In addition, different processing configurations are possible, such as parallel processors.

The software may include a computer program, a piece of code, an instruction, or some combinations thereof, for independently or collectively instructing or configuring the processing device to operate as desired. Software and/or data may be embodied permanently or temporarily in any type of machine, component, physical equipment, virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more computer readable storage mediums.

The methods according to the above-described example embodiments may be configured in a form of program instructions performed through various computer devices and recorded in non-transitory computer-readable media. The media may also include, alone or in combination with the program instructions, data files, data structures, and the like. The media may continuously store computer-executable programs or may temporarily store the same for execution or download. Also, the media may be various types of recording devices or storage devices in a form in which one or a plurality of hardware components are combined. Without being limited to media directly connected to a computer system, the media may be distributed over the network. Examples of the media include magnetic media such as hard disks, floppy disks, and magnetic tapes; optical media such as CD-ROM and DVDs; magneto-optical media such as floptical disks; and hardware devices that are specially configured to store and perform program instructions, such as ROM, RAM, flash memory, and the like. Examples of other media may include recording media and storage media managed by an app store that distributes applications or a site, a server, and the like that supplies and distributes other various types of software.

While this disclosure includes specific example embodiments, it will be apparent to one of ordinary skill in the art that various alterations and modifications in form and details may be made in these example embodiments without departing from the spirit and scope of the claims and their equivalents. For example, suitable results may be achieved if the described techniques are performed in a different order, and/or if components in a described system, architecture, device, or circuit are combined in a different manner, and/or replaced or supplemented by other components or their equivalents.

What is claimed is:

1. A method of operating a computer system including at least one processor configured to execute computer-readable instructions included in a memory, the method comprising:
analyzing, by the processor, an interest of a user based on information related to the user;
selecting, by the processor, at least one transportation method, from among a first plurality of transportation methods, as an information display method,
the selected at last one transportation method being a transportation method that is expected to pass the user,
the selecting being based on a location of the user and a location of each transportation method from among the first plurality of transportation methods; and
providing information data corresponding to the interest through an external digital display of the selected at least one transportation method.

2. The method of claim 1, wherein the analyzing comprises:
collecting the information related to the user through interaction with at least one of an application installed in an electronic device of the user and a service platform used by the user.

3. The method of claim 1, wherein the analyzing comprises:
determining a target range by analyzing at least one of a current season, a time zone, a social issue, and profile information including at least one of an age, a gender, an occupation, and an area of the user.

4. The method of claim 1, wherein the analyzing comprises:
when a plurality of users is present in the same place as a target to which the information data is to be provided, collecting information for each user and determining a target range based on statistics or a distribution of the collected information.

5. The method of claim 1, wherein the selecting comprises:
selecting, as the information display method, a transportation method of which an estimated time of arrival to the location of the user is less than or equal to an estimated time of arrival of a specific transportation method the user is expected to board.

6. The method of claim 1, wherein the selecting comprises:
selecting, as the information display method, a transportation method that is present between the location of the user and a location of a specific transportation method the user is expected to board.

7. The method of claim 1, wherein the selecting comprises:
when a plurality of users is present in the same place as a target to which the information data is to be provided, selecting the information display method by including a transportation method at least partially overlapping between users based on an interest for each user.

8. The method of claim 1, wherein the providing comprises:
when a second plurality of transportation methods, from among the first plurality of transportation methods, is selected as the information display method, providing different information data through an external digital display of each transportation method from among the second plurality of transportation methods.

9. The method of claim 1, wherein the providing comprises:
when a second plurality of transportation methods, from among the first plurality of transportation methods, is selected as the information display method, applying time information according to a remaining distance or an estimated time of arrival to the location of the user for each transportation method from among the second plurality of transportation methods and providing the information data through an external digital display of a corresponding transportation method.

10. The method of claim 1, wherein the providing comprises:
providing the information data by jointly using at least one of a digital display installed in a boarding place of the transportation method and a digital display installed in an outdoor facility around the boarding place.

11. The method of claim 1, wherein the providing comprises:
providing information data related to at least one of a local facility included in a route of a specific transportation method boarded by the user and a destination of the user through an internal digital display of the specific transportation method.

12. The method of claim 1, wherein the providing comprises:
providing at least a portion of the information data through an application installed in an electronic device of the user after the user boards a specific transportation method.

13. A non-transitory computer-readable record medium storing instructions that, when executed by a processor, cause the processor to perform the method of claim 1.

14. A computer system comprising:
memory storing computer-readable instructions; and
at least one processor configured to execute the computer-readable instructions such that the processor is configured to,
analyze an interest of a user based on information related to the user,
select at least one transportation method, from among a first plurality of transportation methods, as an information display method,
the selected at last one transportation method being a transportation method that is expected to pass the user,
the selecting being based on a location of the user and a location of each transportation method from among the first plurality of transportation methods, and
provide information data corresponding to the interest through an external digital display of a transportation method selected as the information display method.

15. The computer system of claim 14, wherein the at least one processor is further configured to collect the information related to the user through interaction with at least one of an application installed in an electronic device of the user and a service platform used by the user and to analyze the interest.

16. The computer system of claim 14, wherein the at least one processor is further configured to, when a plurality of users is present in the same place as a target to which the information data is to be provided, collect information for each user and determine a target range based on statistics or a distribution of the collected information.

17. The computer system of claim 14, wherein the at least one processor is further configured to select, as the information display method, a transportation method of which an estimated time of arrival to the location of the user is less than or equal to an estimated time of arrival of a specific transportation method the user desires to board, or a transportation method that is present between the location of the user and a location of the specific transportation method the user is expected to board.

18. The computer system of claim 14, wherein the at least one processor is further configured to, when a second plurality of transportation methods, from among the first plurality of transportation methods, is selected as the information display method, provide different information data through an external digital display of each transportation method from among the second plurality of transportation methods.

19. The computer system of claim 14, wherein the at least one processor is further configured to provide the information data by jointly using at least one of a digital display installed in a boarding place of the transportation method and a digital display installed in an outdoor facility around the boarding place.

20. The computer system of claim 14, wherein the at least one processor is further configured to provide information data related to at least one of a local facility included in a route of a specific transportation method boarded by the user and a destination of the user through an internal digital display of the specific transportation method.
